(19) United States
(12) Patent Application Publication
(10) Pub. No.: US 2004/0213085 A1
(43) Pub. Date: Oct. 28, 2004

(54) Shield for electric mixers

(76) Inventor: Barbara R. Estes, Irvine, KY (US)

Correspondence Address: Barbara R. Estes, 336 Turner Avenue, Irvine, KY, 40336-1270, US

(21) Appl. No.: 10/411,946

(22) Filed: Apr. 14, 2003

(51) Int. Cl. B01F 15/00

(52) U.S. Cl. 366/347

(57) ABSTRACT

A shield of variable diameter size, for use with all electric mixers, the fitting of which is determined only by shaft(s) of specified mixer. The shield is a basically thin round disk of rigid plastic material having a slot extending from the outer edge to the center. The slot is the unique feature that sets the invention apart from all previous attempts to invent a mixer shield. All other invented shields have had a central aperture or pair of holes or have had various parts resulting in various complicated fitting and attachments. What is new is that it is a one-piece mixer shield but is not a lid (except as an option can fit as a lid for the stand mixer). New also is the fact that it will work equally well on any hand-held or stationary mixer or industrial mixer; only sizes will vary.

The proposed invention is a shield for electric mixers which allows quick and easy application and provides total protection from splatter and is so versatile that it will work on any hand-held or stand mixer. The shield is a generally round, although not limited to, transparent or opaque rigid plastic disk having only a narrow slot extending from the outer edge surface to center of disk. The inventor is Barbara R. Estes, U.S. Citizen, residence 336 Turner Avenue, Irvine, Ky. 40336-1270.

### CROSS-REFERENCE TO RELATED APPLICATIONS

Not Applicable.

### REFERENCES CITED

U.S. Pat. Documents

| | | | |
|---|---|---|---|
| 4822175 | April, 1989 | Barnard et al. | 366/347. |
| 5439289 | August, 1995 | Nielson | 366/207. |
| 5533806 | July, 1996 | Veltrop et al. | 366/347. |
| 5556203 | September, 1996 | Filias | 366/347. |
| 5660469 | August, 1997 | Seguin | 366/347. |
| 5893640 | April, 1999 | Myers | 366/129. |
| 6123449 | September, 2000 | Sadek-Patt | 366/347. |
| 6176610 | January, 2001 | Myers et al. | 366/347. |

### STATEMENT REGARDING FEDERALLY SPONSORED RESEARCH OR DEVELOPMENT

The mixer shield is described without any funding from federally sponsored research or development.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This proposed invention relates to a mixing process of which every cook dreams. This is a shield that allows quick and easy application and provides maximum splatter protection. That means, for example, that a pan of potatoes can be cooked ready for mashing, then position the mixer ready for mashing and simply slide on the mixer shield. It works perfect for any ingredients, hot or cold.

The proposed mixer shield is the only one having no attachments and having no need to fit as a lid. It is a one-piece shield, therefore having no assembly or mounting arrangements. There is nothing in the way causing a hindrance to usage. The distinct narrow slot in this invention sets it apart from all other inventions. It is the only mixer shield that does not have an aperture or pair of holes in the center or else have various complicated parts which have to be connected. This provides also for a more pleasing and complimentary appearance. It is the only disk-shaped plate-like shield that covers the container while also connecting onto the mixer blade shaft simply by sliding thereon from either side. This is a mixer shield wherein the entire basic idea for the hand-held mixers, stand mixers and industrial mixers is simply the accommodating size diameter shield covering the container and the accommodating size slot fitting the mixer blade shaft(s).

In U.S. Pat. No. 4,822,175, Barnard proposes a splash guard for a food mixer. He states it has a housing from which a food agitator downwardly extends including a base plate having an opening therein, a ring member positioned above the base plate surrounding the agitator, rod members carrying the base plate and ring member so that when a cup is placed below the base plate and moved vertically, the base plate and ring member move upwardly with the rod member while the agitator enters the cup. This is unnecessary complication. My proposed simple slotted round disk slides over top of the container and at the same time onto the mixer shaft, providing protection immediately.

An invention is proposed by Nielson in U.S. Pat. No. 5,439,289. In his proposal the mixer shaft extends downwardly through the aperture of a lid. My proposed shield more thoroughly covers the container by not having an aperture and slides on for immediate operation.

The mixing bowl splatter guard, U.S. Pat. No. 5,123,449 proposed by Sadek-Patt may be the simplest thus far attempt to solve the splatter problem. This is a guard that attaches like a lid (with friction components) on to the bowl. It has a central aperture for the mixer blades and for addition of ingredients. This patent also has a slot for getting to the aperture. With my invention, the slot has a total different purpose. Because the slot is a slot only, no aperture, it holds the shield firmly in place. The slot also provides more shield protection than the aperture. Therefore, with my proposal, the shield moves with the mixer blades reaching all contents of any size bowl or container and the slot serves the unique purpose of not only sliding onto the mixer blade shaft but holding the shaft in place thereby allowing the cook to move the hand-held mixer around the sides of any size container. Of course with the stand mixer, the slot's only purpose need be to hold the shaft firm while covering the container. My proposal is not a bowl cover but rather a universal mixer shield. Being an instant shield instead of a lid, there is no hassle with fitting it onto the bowl and no crevices making it hard to clean.

In U.S. Pat. No. 6,176,610, Myers offers a splash guard that has mutually-opposed flanges fitting in grooves in the sides of the mixer body. Myers states that the grooves can be specially provided for mounting the splash guard or they can be formed in a conventional manner at the junction of two body parts secured together to form the mixer body. The splash guard includes a transverse retainer strap and has snap-fitting and sliding methods of assembly. My proposal allows quick and easy application and maximum shielding protection with zero assembly and no added parts.

The cover unit for an industrial food mixer, U.S. Pat. No. 5,660,469 is made of two covers that are mounted by hinges with a splash rib then mounted on each cover. The cover's opening is made of two matching cutouts, one on each cover. The covers move between an open condition (for uncovering the bowl) and a closed condition (for covering the bowl) and have a locking mechanism for locking closed. All this is simply unnecessary with my proposal. The shield I propose simply slides onto the shaft and stays there as long as is needed and can be slid off for any reason the cook desires.

In U.S. Pat. No. 5,556,203 Filias proposes a splash guard which, as other prior inventions, has holes in the center of guard for accommodating the shafts of the mixer and has to be attached to the mixer by hook and loop fasteners, none of which are necessary for my proposed invention.

Since there is a significant problem with the operation of hand-held mixers and stand mixers ever since they have been invented it is of major importance that there be a mixer shield that can be a standard accessory. During the operation of any mixer, it is a known fact that without protection the mixer blades sling ingredients out of the mixing container. As long as there have been mixers this persisting problem has never been satisfactorily solved. Many inventors have made various attempts to find solutions to the longtime problem of mixer slinging. The solutions so far have been too complicated to be commercially successful. The only mixer shield invention that will be commercially successful will be very simple, effective and attractive. It will be so commercially successful that consumers should be able to go in Wal-Mart, K-Mart, etc. and purchase one. At the present, there are very few shields available to the consumer. There are no stand mixers on the market that have a slide-on mixer shield. There is no slide-on shield on the market available for the hand-held mixer. There needs to be a mixer shield manufactured that is both simple and effective that can be sold with mixers or sold separately. It will be appealing to buyers only if it is simple and if it works. The round slotted disk proposed in this patent application meets all specifications that will be pleasing to consumers. It would no doubt increase the sale of mixers.

This proposed invention covers every aspect of every problem of using a mixer. Its uniqueness lies in the fact that it is the only shield which allows full view of the contents of the container while allowing movement of the hand-held mixer to reach all areas of the container while having a feature allowing it to slide on or off easily. The slide-on and slide-off feature makes it easy to add new ingredients during the mixing process. Also the shield serves as a resting platform for the mixer at any time the cook chooses to turn the mixer off for any reason. It does it all without a need for any kind of friction components or fastening attachments. The shield for a stand mixer, whether or not it is a simple flat shield or a lid-fitting shield (which could be an optional feature), would also add to the attractiveness of the mixer.

The entire basic idea for the mixer shield for hand-held mixers, stand mixers, or industrial size mixers is simply the accommodating size slot for fitting the mixer blade shaft(s). Whether or not there are notches or any kind of flap-down closure of the slot is optional. Whether or not there are two slots (for sliding on from the front of mixer) or one slot (as I propose, for sliding on from a side) it is the same invention. Whether or not a manufacturer may want to make a tab for handling an edge of the shield is optional. And the manufactured size shield would simply be determined by desire of the user. Also optional would be if the manufacturer desired to make the shield fit as a lid for the stand mixers (if he should think it to be more appealing than the basic shield). Though my invention is a simple shield with a slot, it allows for many little features that does not in any way change the operational results of same invention. It is important that within the scope of the claims it is understood that various designs of this invention will not deter from the original idea as long as it remains a covering with a slot for sliding over the container and onto the mixer shaft(s).

### BRIEF SUMMARY OF THE INVENTION

The summary of my invention is based on the unique simplicity that a transparent or opaque slotted plastic disk of desired size has the versatility to serve as a complete shield for a hand-mixer, stand mixer or industrial mixer. With mixer blades positioned in the container of ingredients, the shield can be slid on from either side of the mixer shaft(s). It works to move with the hand mixer and it works to remain stationary on the stand mixer or industrial mixer. It more thoroughly covers the container than previously patented shields that have the aperture or two holes. It is the only shield for a hand-held mixer that allows full view of substance being mixed in container with no central aperture while allowing movement of the mixer to reach all areas of the container while having the slide-on and slide-off feature for addition of ingredients. The object of the invention is to provide a no-hassle shield that can be used quickly and easily. A perfect example comes from the moment of concept of the idea: A pan of cooked potatoes ready to be mashed is covered with my proposed shield, thereby allowing quick and easy removal for addition of ingredients, and thereby providing a resting platform for the mixer during any interruption of mixing.

Mixer shield size is optional, but in most cases (except for the industrial size mixer) a shield about the size of a dinner plate or about 10 inches would be sufficient. Though round seems to be the most logical shape, variations in shape will not affect the invention as long as the diameter is sufficient. The slot size can range from 6 mm to 13 mm in width, or the widths of any mixer shafts. This will be determined by whether it is manufactured for a hand-held mixer or a stand mixer. Also optional will be whether there is a notch (or notches) at the end of the slot (center of shield) for extra grip on the mixer blade shaft. Another option for the wider slot for the wider shaft is a snap-down closure which would also give extra grip. If the snap-down closure is used it would need an outer tab for easy handling. The shield for the stand mixer may be the basic shield or it can be made to fit as a lid, whichever the manufacturer believes to be the most complimentary to the mixer.

The basic shield is round and of transparent plastic material and having a narrow slot starting from outer edge with smooth transition and leading to center. Size of the shield will vary. Any other detail aforementioned is optional.

The main object of the invention is to provide to the public a mixer shield that is so simple it can be quickly and easily applied at the instant it is needed while providing the utmost desired protection from slinging ingredients; and also to provide a mixer shield that is so simple it can be removed just as quickly and easily as it was applied.

### BRIEF DESCRIPTION OF THE SEVERAL VIEWS OF THE DRAWING

FIG. 1 shows a top view of the basic round slotted mixer shield.

FIG. 2 shows a perspective view of the round slotted mixer shield in position for sliding from the left onto the mixer shaft of hand-held mixer positioned in container ready for mixing.

FIG. 3 shows a perspective view of the slotted mixer shield in position for sliding onto the mixer shaft of stand mixer ready for mixing.

FIG. 4 shows a perspective view of mixer shield fitted with the hand-held mixer ready for operation.

FIG. 5 shows a perspective view of mixer shield fitted with the stand mixer ready for operation.

### DETAILED DESCRIPTION OF THE INVENTION

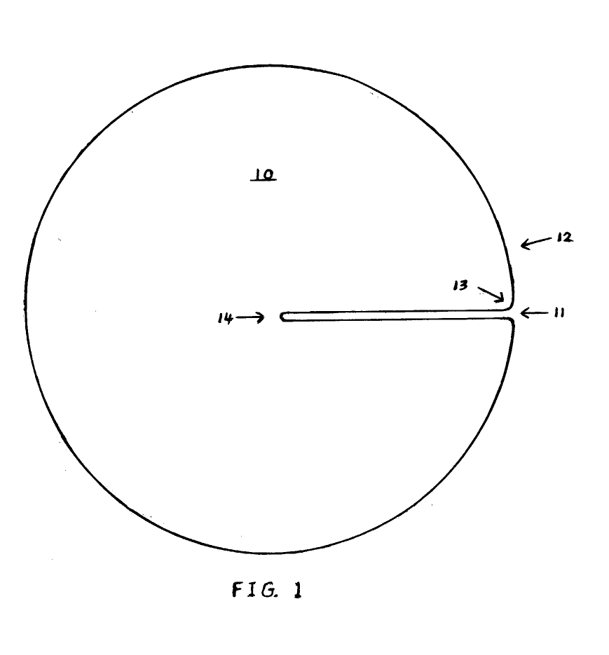

FIG. 1 shows the top view of the slotted circular mixer shield 10 as the present invention. The shape, if manufacturers choose, however, is not limited to round as long as it is a size and shape sufficient for covering the desired container. The width of slot will be determined by the mixer blade shaft(s) for which it is being manufactured. The following descriptions relating to the stand mixer will apply in the same way to an industrial mixer.

The slotted mixer shield 10 is made of a transparent or opaque rigid plastic material determined by the manufacturer. Its versatility even allows it to be the same on both sides so that there need not be any differentiation between top and bottom of the shield. The outer edge surface 12 of the slot 11 has smooth transitional edges 13 for an easy glide entrance onto the mixer blade shaft(s) and the curved ending 14 of slot 11 at center of shield 10 provides the resting place for holding the shaft(s). After it is fitted on ready for operation of hand-held mixer, it has two major functions, that being: it covers the container of ingredients completely and it moves with the mixer as it keeps the container covered. It is the simplicity of the design and the unequalled function of the present invention that will make it so appealing to consumers.

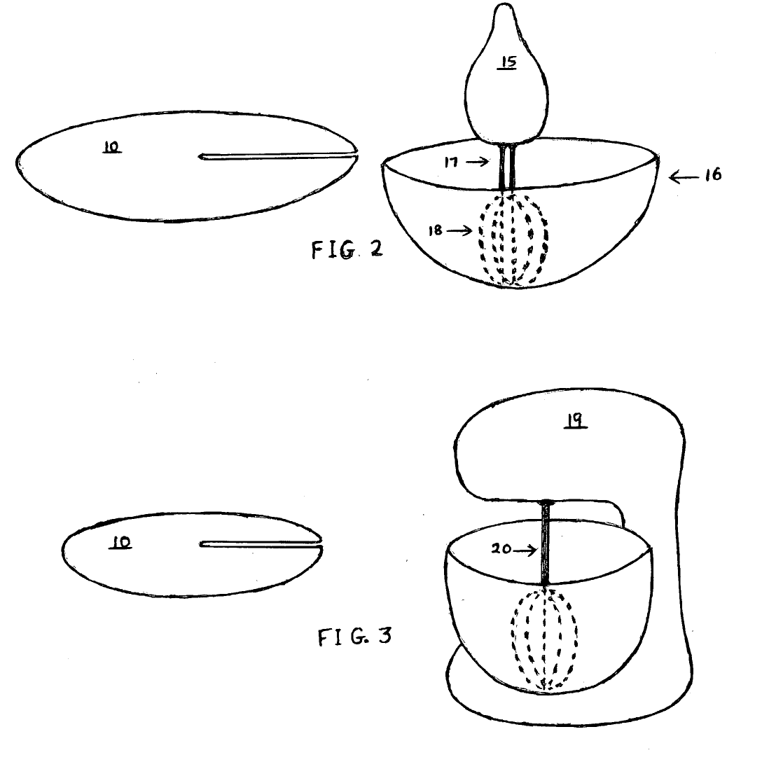

FIG. 2 shows the mixer shield 10 in position from left ready for sliding onto the mixer blade shaft(s) 17 of a hand-held mixer 15 positioned with beater blades 18 in the container 16 ready for mixing. It is the simplicity and efficiency that will cause every cook to desire to reach for the present invention every time they use a hand mixer. Part of that reason is because, though the drawing shows the mixer shield 10 going on from the left, it works exactly the same for a left-handed person who chooses to slide it on from the right side.

FIG. 3 shows the mixer shield 10 in position for sliding from any angle onto a single shaft 20 of stand mixer 19.

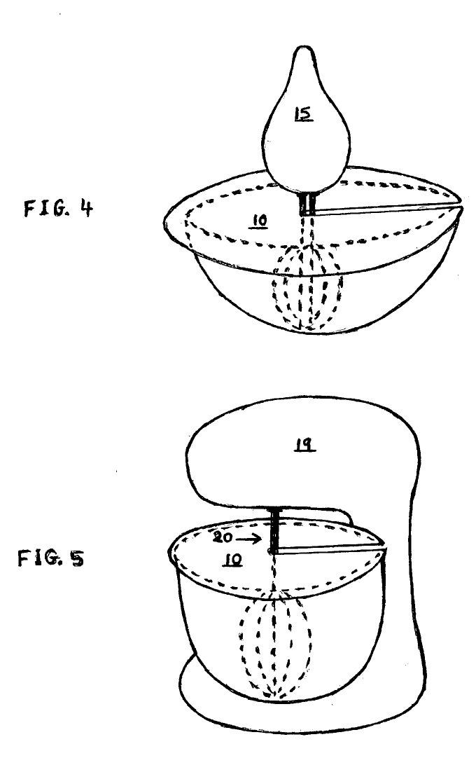

FIG. 4 shows the mixer shield 10 in position with a hand-held mixer 15 ready for the mixing process. As the drawing of present invention illustrates, the mixer shield 10 also provides a sturdy stand for the mixer even when not in operation.

FIG. 5 shows the mixer shield 10 in position on a single shaft 20 on a stand mixer 19 ready for mixing. As the drawing illustrates, with a mixer which has a single shaft 20 the shield can glide on from any angle directed toward the stand. The mixer shield is so simple that it does not in any way detract from the attractiveness of the stand mixer 19. Furthermore, it is seen as a very complimentary accessory.

It is to be understood that within the scope of claims and specifications the designs of the described invention are not limited as long as the shield is a covering and has a slot for holding the mixer blade shaft(s).

I claim:

1. An electric mixer shield for hand-held mixers and stand mixers comprised of a round rigid plastic disk having only a narrow slot extending from the outer edge surface to center of disk.

2. A mixer shield as stated in claim 1 wherein disk is made of rigid plastic material.

3. A mixer shield as stated in claim 1 wherein disk is transparent or opaque.

4. A mixer shield as stated in claim 1 wherein disk is manufactured to any desired diameter for use with any desired size container.

5. A mixer shield as stated in claim 1 wherein slot is 6 mm to 13 mm or larger, to accommodate the widths of mixer shafts.

6. A mixer shield as stated in claim 1 wherein thickness of disk is approximately 1.5 mm to 7 mm.

7. A mixer shield as stated in claim 1 wherein the slot is straight and narrow.

8. A mixer shield as stated in claim 1 wherein the slot has a smooth transitional outer surface edge for easy slide-on effect.

9. A mixer shield as stated in claim 1 wherein the slot ends with smooth curve at center of the mixer shield.

10. A mixer shield as stated in claim 1 wherein it may be alike on both sides (top and bottom).

11. A mixer shield as stated in claim 1 wherein its connection to the mixer shaft is a choice of from the right side or the left side.

12. A mixer shield as stated in claim 1 wherein its application is for hot or cold ingredients.

13. A mixer shield as stated in claim 1 wherein the design is so basic that the addition of various optional features would not fundamentally change the operational results of the invention.
